(19) United States
(12) Patent Application Publication
(10) Pub. No.: US 2007/0081464 A1
(43) Pub. Date: Apr. 12, 2007

(54) Real-time performance monitoring of ethernet data over sonet

(75) Inventors: Hari P. Miriyala, Cupertino, CA (US); Anuj Jain, San Jose, CA (US); Jiyang Liu, San Jose, CA (US)

Correspondence Address: Edward A. Pennington;Swidler Berlin LLP, Suite 300, 3000 K Street, N.W., Washington, DC, 20007, US

(73) Assignee: Fujitsu Network Communications, Inc.

(21) Appl. No.: 11/246,286

(22) Filed: Oct. 11, 2005

(51) Int. Cl. H04L 12/28; H04L 12/26

(52) U.S. Cl. 370/241; 370/254

(57) ABSTRACT

A technique for performing Real-time Monitoring (RTM) of performance management data related to SONET data, SDH data, WDM data, Ethernet data and video data transmitted over a telecommunications network is provided. RTM allows the collection of performance management data at a rate that is sufficient to provide meaningful information for trouble shooting, optimizing, and determining the performance of telecommunication networks managed by a Network Management System, such as a SONET network, a WDM network and a SDH network. Performance management data can be viewed as it is retrieved from network elements.

### BACKGROUND OF THE INVENTION

1. Field of the Invention

The present invention relates to a method, system, and computer program product for monitoring a telecommunications network, and more particularly a method, system, and computer program product for real-time monitoring of performance management data transmitted over a telecommunication network.

2. Description of the Related Art

As telecommunications services have proliferated, telecommunications networks have become increasingly complex. Today, telecommunications networks, using technologies such as Synchronous Optical Network (SONET), Dense Wavelength Division Multiplexing (DWDM), Synchronous Digital Hierarchy (SDH), Asynchronous Transfer Mode (ATM), Ethernet, etc., may extend world-wide and may include thousands of network elements (NEs). Protocols have been developed that allow Ethernet services to be used on SONET and SDH networks. Through the use of Virtual Concatenation (VC), Link Capacity Adjustment Scheme (LCAS) and the Generic Framing Procedure (GFP) protocols, services are now offered over SONET and SDH that are flexible and efficient.

Typically, SONET and SDH networks include network management systems (NMSs) that provide the capability to manage, provision, maintain and determine the performance of the thousands of network elements. A network management system provides these capabilities through the collection of performance management data, such as SONET data, SDH data, WDM data, Ethernet data and video data, from network elements on the network. Typically, the performance management data of a network element is collected by a network management system at specified intervals, such as 15 minute and 24 hour intervals, through autonomous reporting by the network element, polling of the network element by the network management system, or both. The collection of performance management data at these intervals to analyze network performance is usually appropriate for SONET data, SDH data, WDM data and the like because they may not change significantly within these intervals. However, in some instances, such as trouble shooting, performance management data related to SONET data, SDH data and WDM data collected at these intervals do not provide sufficient information for meaningful analysis of network performance.

SONET, SDH, and WDM networks that provide Ethernet services implement cumulative counters in network elements to compute the amount of Ethernet data and video data transmitted over these networks. As the Ethernet data is transmitted over these networks, the cumulative counters in the network elements through which the Ethernet data passes incremented in real-time. Typically, several thousand frames of Ethernet data is transmitted through a network element in a second. The analysis of performance management data related to these cumulative counters is useful in optimizing and determining the performance of the networks. However, performance management data related to Ethernet data and video data changes at a rate faster than it is collected in these networks. As a result, performance management data related to Ethernet data and video data obtained at the normal intervals do not provide sufficient information for optimizing and determining the performance of the network.

A need arises for a technique by which performance management data related to SONET data, SDH data, WDM data, Ethernet data and video data and the like is collected in real-time. In addition, a need arises for a technique by which the performance management data related to Ethernet data and video data is retrieved from a network element. In addition, a need arises for a technique of viewing the performance management data in real-time. In addition, a need arises for a technique of viewing the performance management data in real-time for a specified period of time. In addition, a need arises for viewing the performance management data in its native format. In addition, a need arises for viewing the performance management data in an interpreted format. In addition, a need arises to be able to identify when the performance management data has reached a threshold value.

### SUMMARY OF THE INVENTION

The present invention provides a technique for performing Real-time Monitoring (RTM) of performance management data related to SONET data, SDH data, WDM data, Ethernet data and video data transmitted over a telecommunications network. RTM allows the collection of performance management data at a rate that is sufficient to provide meaningful information for trouble shooting, optimizing, and determining the performance of telecommunication networks managed by a Network Management System, such as a SONET network, a WDM network, a SDH network and the like. The present invention retrieves performance management data related to SONET data, SDH data, WDM data, Ethernet data and video data from a network element as the data is generated by the network element. In addition, the present invention allows the performance management data to be viewed as it is retrieved from the network element. In addition, the present invention allows performance management data to be viewed for a specified period of time. In addition, the present invention provides performance management data for viewing in an interpreted and native format. In addition, the present invention indicates when performance management data has exceeded a threshold value.

In an embodiment of the present invention, a method of performing real time monitoring of performance management data on a network comprises the steps of:(a) issuing a request for performance management data from a network element on the network; (b) receiving the performance management data from the network element in response to the request; (c) present the performance management data in a form suitable for visual and tabular interpretation; and (d) determining if a specified time interval has elapsed. If the specified time interval has not elapsed then the steps (a) through (d) are repeated at a rate supportable by the network element and the network.

In an aspect of the present invention, the requests is issued to the network element as fast as the network element can respond and the network can process the request.

In an aspect of the present invention, the network is a SONET network, WDM network or a SDH network.

In an aspect of the present invention, the performance management data is related to at least one of: SONET data, SDH data, WDM data, Ethernet data, and video data.

In an aspect of the present invention, the request is for one type of performance management data.

In an aspect of the present invention, the request is for multiple types of performance management data.

In an aspect of the present invention, the performance data is provided in a report.

In an aspect of the present invention, the performance management data is provided on a visual display.

In an aspect of the present invention, the performance management data is provided in a native format.

In an aspect of the present invention, the performance management data is provided in an interpreted format.

### BRIEF DESCRIPTION OF THE DRAWINGS

The preferred embodiments of the present invention will be described with reference to the accompanying drawings.

FIG. 1 is an exemplary block diagram of a network management system 100, in which the present invention may be implemented;

FIG. 2 is an exemplary data flow diagram of a RTM process according to the present invention; and

FIG. 3 is an exemplary display of performance management data being monitored in real-time according to an embodiment of the present invention.

### DETAILED DESCRIPTION OF THE PREFERRED EMBODIMENTS

The present invention provides a technique for performing Real-time Monitoring (RTM) of performance management data related to SONET data, SDH data, WDM data, Ethernet data and video data transmitted over a telecommunications network. RTM allows the collection of performance management data at a rate that is sufficient to provide meaningful information for trouble shooting, optimizing, and determining the performance of telecommunication networks managed by a Network Management System, such as a SONET network, a WDM network, a SDH network and the like. The present invention retrieves performance management data related to SONET data, SDH data, WDM data, Ethernet data and video data from a network element as the data is generated by the network element. In addition, the present invention allows the performance management data to be viewed as it is retrieved from the network element. In addition, the present invention allows performance management data to be viewed for a specified period of time. In addition, the present invention provides performance management data for viewing in an interpreted and native format. In addition, the present invention indicates when performance management data has exceeded a threshold value.

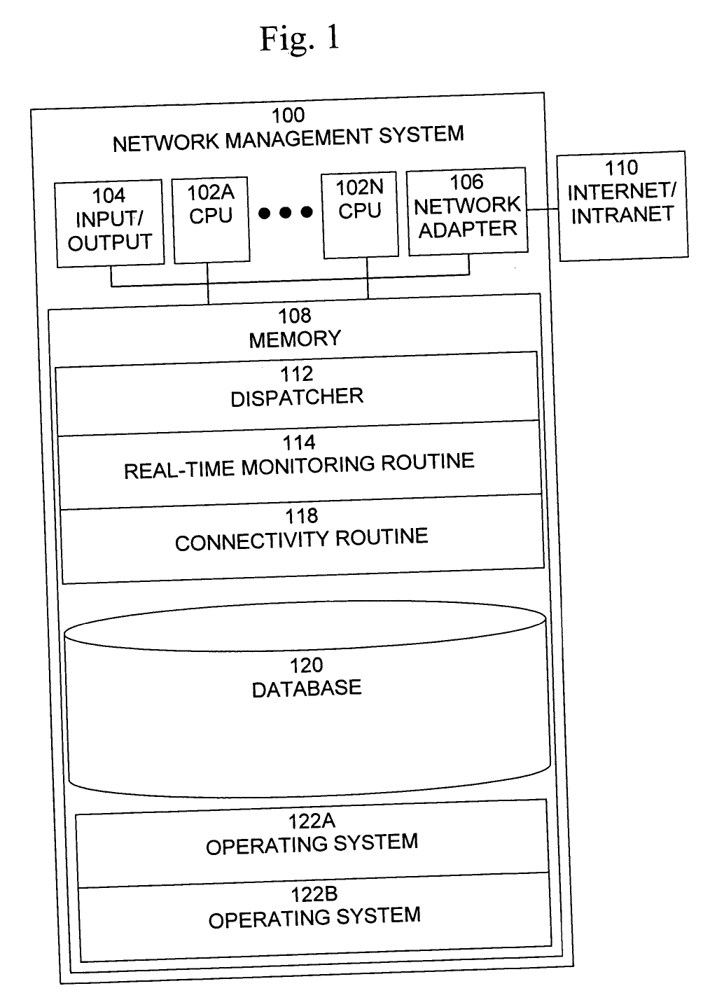

An exemplary block diagram of a network management system 100, in which the present invention may be implemented, is shown in FIG. 1. Network management system 100 is typically a programmed general-purpose computer system, such as a personal computer, workstation, client/server system, and minicomputer or mainframe computer, but may also be a programmed special-purpose computer, custom circuitry, or the like.

Network management system 100 includes one or more processors (CPUs) 102A-102N, input/output circuitry 104, network adapter 106, and memory 108. CPUs 102A-102N execute program instructions in order to carry out the functions of the present invention. Typically, CPUs 102A-102N are one or more microprocessors, such as an INTEL PENTIUM® processor, or SPARC® RISC processor. FIG. 1 illustrates an embodiment in which network management system 100 is implemented as a single multi-processor client/server system, in which multiple processors 102A-102N share system resources, such as memory 108, input/output circuitry 104, and network adapter 106.

However, the present invention also contemplates embodiments in which network management system 100 is implemented as a plurality of networked computer systems, which may be single-processor computer systems, multi-processor computer systems, or a mix thereof.

Input/output circuitry 104 provides the capability to input data to, or output data from, network management system 100. For example, input/output circuitry may include input devices, such as keyboards, mice, touchpads, trackballs, scanners, etc., output devices, such as video adapters, monitors, printers, etc., and input/output devices, such as, modems, etc. Network adapter 106 interfaces network management system 100 with Internet/intranet 110. Internet/intranet 110 may include one or more standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of network management system 100. Memory 108 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface. In the example shown in FIG. 1, memory 108 includes dispatcher 112, RTM routine 114, connectivity routine 118, database 120, and operating systems 122A and 122B.

Dispatcher 112 monitors the amount of system resources available and using the system resources available, the weight, and the priority of operations pending, controls execution of operations in order to streamline execution of the operations. RTM routine 114 implements the real-time monitoring process for collecting performance management data from a network element on a network in real-time. Connectivity routine 118 provides services that allow multiple processes running on one or more machines to interact across a network. In an embodiment of the present invention, connectivity routine 118 implement A client/server architecture, such as a Common Object Request Broker Architecture (CORBA). Operating systems 122A and 122A provide overall system functionality. In an embodiment of the present invention, operating system 122A is a server operating system, such as a Solaris® operating system. In an embodiment of the present invention, operating system 122B is a client operating system, such as a Windows® NT or a Window® 2000 operating system.

As shown in FIG. 1, the present invention contemplates implementation on a client/server system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

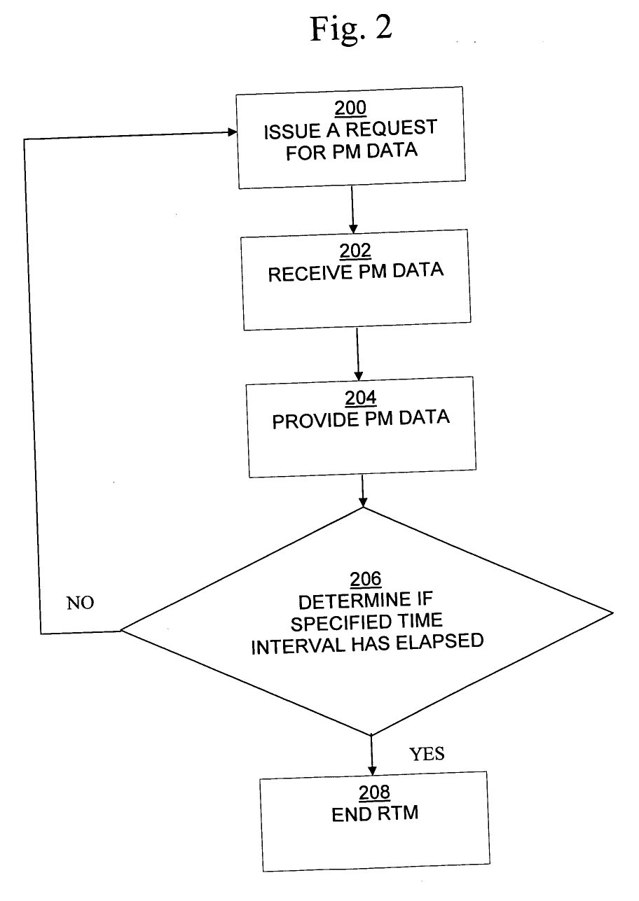

An exemplary data flow diagram of a RTM process according to the present invention is shown in FIG. 2. The process begins in step 200. In step 200, network management system 100 issues a request for performance management data from a network element. Requests can be issued to a network element successively as fast as the network element can respond and the network can process. In an embodiment of the present invention, multiple requests can be issued to perform parallel RTM processing of various types of performance management data. In the FIG. 2 embodiment of the present invention, the request can be for performance management data related to any one of SONET data, SDH data, WDM data, Ethernet data, video data and the like. In an embodiment of the present invention, the network is a telecommunications network transmitting voice data, video data, Ethernet data or any combination thereof. In an embodiment of the present, the network element is on a SONET network. In an embodiment of the present invention, the network element is on a WDM network. In an embodiment of the present invention, the network element is on a SDH network. In an embodiment of the present invention, the request can be for a particular type of performance data. In an embodiment of the present invention, the request can be multiple types of performance management data. In an embodiment of the present invention, the request also specifies a threshold value to retrieve for a particular type of performance management data.

In step 202, the network management system receives the performance management data from the network element in response to the request. In an embodiment of the present invention, multiple types of performance management data is simultaneously received in response to a request for the multiple types of performance management data. In an embodiment of the present invention, a particular type of performance management data is received in response to a request for the particular type of performance management data.

In step 204, the network management system provides RTM data to a user. In the FIG. 2 embodiment of the present invention, RTM data includes, but is not limited to requested performance management data, RTM process status information, RTM process progress information and the like. In an embodiment of the present invention, RTM process status information includes, but is not limited to, the amount of time that a RTM process has been in progress, whether a RTM process has been suspended, whether a RTM process has stalled, the reason for a stalled RTM process and the like. In an embodiment of the present invention, RTM process status information is provided on a visual display. In an embodiment of the present invention, RTM process progress information includes, but is not limited to, the amount of time left in a RTM process, the number of performance management data samples obtained since the initiation of a RTM process and the like. In the FIG. 2 embodiment of the present invention, the RTM data is provided on a visual display. In an embodiment of the present invention, multiple types of performance management data can be provided for analysis on a single graph. In an embodiment of the present invention, multiple types of performance management data can be provided for analysis where each type of performance management data is on a separate graph. When multiple types of performance management data is plotted in a single graph they are visually differentiated, such as by plotting each type of performance management data in a particular color, and legends indicate which plot belongs to which type of performance management data.

In an embodiment of the present invention, the performance data is provided in a report. In an embodiment of the present invention, the performance management data is saved. In an embodiment of the present invention, the performance management data is saved in at least one of a visual format and a report format. In an embodiment of the present invention, performance management data is provided in the format it was received from the network element. In an embodiment of the present invention, the performance data is provided in an interpreted format where the difference between the current performance management data and the previous performance management data is provided to the user (Relative Performance Management data). In an embodiment of the present invention, the performance data is provided in an interpreted format where the difference between the current performance management data and the previous performance management data is provided to the user over the time difference elapsed between the current performance management data and the previous performance management data (Rate of Change). The performance management data can be saved and printed in a graphical and report format.

In an embodiment of the present invention, the visual display can indicate when performance management data has exceeded a threshold level. The threshold value set for a particular performance management data is compared with received performance management data. Once it is determined that the performance management data has exceeded the threshold value, the performance management data is designated with some characteristic to denote that it has exceeded the threshold value. In an embodiment of the present invention, the performance management data is designated with a color.

In step 206, it is determined whether a specified period of time has elapsed. In the FIG. 2 embodiment of the present invention, the period of time to perform the RTM process is specified. In an embodiment of the present invention, the period of time is up to 10 minutes. In an embodiment of the present invention, the period of time is from 1 minute to 30 minutes. In an embodiment of the present invention, the RTM process can be stopped prior to the elapse of the period of time. In an embodiment of the present invention, the RTM process can be resumed after it has been stopped. A user can stop and resume the RTM process multiple times or as needed within the period of time. In an embodiment of the present invention, the user can view the data for each interval in the period of time when the RTM process was stopped or view data for the entire period of time in a single view. If so, the method proceeds to step 208 where the method ends. If not, the method returns to step 200.

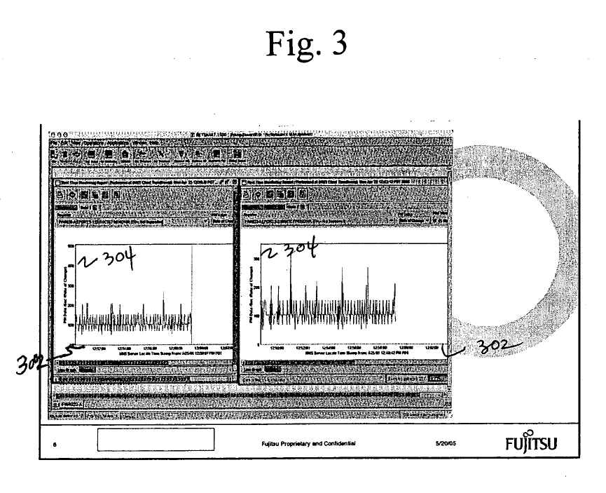

An exemplary display of performance management data being monitored in real-time according to an embodiment of the present invention is shown in FIG. 3. In the FIG.3 embodiment of the present invention, display 300 shows the time performance management data was received from a network element on the x axis 302 and the value of the performance management data on the y axis 304.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What we claims is:

1. A method of performing real time monitoring of performance management data on a telecommunications network comprising the steps of:
(a) issuing a request for performance management data from a network element on the network;
(b) receiving the performance management data from the network element in response to the request;
(c) present the performance management data in a form suitable for visual and tabular interpretation; and
(d) determining if a specified time interval has elapsed,
(e) if not, repeating steps (a) through (d), wherein steps (a) through (d) are repeated at a rate supportable by the network element and the network.

2. A method according to claim 1, wherein the requests is issued to the network element as fast as the network element can respond and the network can process the request.

3. A method according to claim 1, wherein the network is one of: a SONET network, a WDM network and a SDH network.

4. A method according to claim 3, wherein the performance management data is related to at least one of: SONET data, SDH data, WDM data, Ethernet data, and a video data.

5. A method according to claim 1, wherein the request is for one type of performance management data.

6. A method according to claim 1, wherein the request is for multiple types of performance management data.

7. A method according to claim 1, wherein the performance data is provided in a report.

8. A method according to claim 1, wherein the performance management data is provided on a visual display.

9. A method according to claim 8, wherein the performance management data is provided in a native format.

10. A method according to claim 8, wherein the performance management data is provided in an interpreted format.

11. A method according to claim 10, wherein the interpreted format is the difference between the performance management data and previous performance management data.

12. A method according to claim 10, wherein the interpreted format is the difference between the current performance management data and the previous performance management data represented over the time difference elapsed between the current performance management data and the previous performance management data.

13. A system for performing real time monitoring of performance management data on a telecommunications network comprising:
a processor operable to execute computer program instructions; and
a memory operable to store computer program instructions executable by the processor, for performing the steps of:
(a) issuing a request for performance management data from a network element on the network;
(b) receiving the performance management data from the network element in response to the request;
(c) present the performance management data in a form suitable for visual and tabular interpretation; and
(d) determining if a specified time interval has elapsed,
(e) if not, repeating steps (a) through (d), wherein steps (a) through (d) are repeated at a rate supportable by the network element and the network.

14. A system according to claim 13, wherein the requests is issued to the network element as fast as the network element can respond and the network can process the request.

15. A system according to claim 13, wherein the network is one of: a SONET network, a WDM network and a SDH network.

16. A system according to claim 15, wherein the performance management data is related to at least one of: SONET data, SDH data, WDM data, Ethernet data, and a video data.

17. A system according to claim 13, wherein the request is for one type of performance management data.

18. A system according to claim 13, wherein the request is for multiple types of performance management data.

19. A system according to claim 13, wherein the performance data is provided in a report.

20. A system according to claim 13, further comprising a display for providing the performance management data is provided on a visual display.

21. A system according to claim 20, wherein the performance management data is provided in a native format.

22. A system according to claim 20, wherein the performance management data is provided in an interpreted format.

23. A system according to claim 22, wherein the interpreted format is the difference between the performance management data and previous performance management data.

24. A system according to claim 22, wherein the interpreted format is the difference between the current performance management data and the previous performance management data represented over the time difference elapsed between the current performance management data and the previous performance management data.
